(19) United States
(12) Patent Application Publication
(10) Pub. No.: US 2007/0131498 A1
(43) Pub. Date: Jun. 14, 2007

(54) Internal air-exchange spring brake chamber

(75) Inventors: Chuanwu Li, Ruian City (CN); Weijun Deng, Ruian City (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SORL Auto Parts, Inc., Ruian City (CN)

(21) Appl. No.: 11/637,306

(22) Filed: Dec. 12, 2006

(30) Foreign Application Priority Data
Dec. 12, 2005 (CN) 200520142949.1

(51) Int. Cl. B60T 13/04

(52) U.S. Cl. 188/166

(57) ABSTRACT

A spring brake chamber assembly. In one embodiment, the spring brake chamber assembly includes a housing having a first housing and a second housing separated by a divider wall, each of the first housing and the second housing having a wall; a first diaphragm configured to be positioned in the first housing to divide the first housing into a breathing chamber and a pressurized chamber, and reciprocally movable therein between a first position and a second position in response to the introduction and/or exhaustion of compressed air to the pressurized chamber; a second diaphragm configured to be positioned in the second housing to divide the second housing into a ventilation chamber and a brake chamber, and reciprocally movable therein between a first position and a second position in response to the introduction and/or exhaustion of compressed air to the ventilation chamber; and a flow control member passing through the pressurized chamber and extending between the breathing chamber and the ventilation chamber for selectively controlling the flow of air between the breathing chamber and the ventilation chamber, where the wall of the breathing chamber is sealed such that no air directly flows through between the breathing chamber and the atmosphere, and the breathing chamber is in fluid communication with the ventilation chamber through the flow control member.

### CROSS-REFERENCE TO RELATED APPLICATION

This application claims priority of Chinese Patent Application No. 200520142949.1, filed on Dec. 12, 2005, entitled “INTERNAL AIR-EXCHANGE SPRING BRAKE CHAMBER” by Chuanwu Li and Weijun Deng, the disclosure of which is incorporated herein by reference in its entirety.

### FIELD OF THE INVENTION

The present invention is generally related to a brake, and, more particularly, is related to a spring brake chamber assembly having a network of air chambers with an internally breathing mechanism for regulating the flow of air within the network of air chambers.

### BACKGROUND OF THE INVENTION

Spring brakes are widely utilized in the automotive industry. A spring brake typically includes a brake actuator assembly actuated by the selective application of a fluid such as compressed air in a network of chambers. A brake actuator typically has both a service brake actuator housed in a service brake chamber for actuating the brake under normal driving conditions by the application of compressed air therein and a spring brake actuator housed in a spring brake chamber for actuating the brake when air pressure therein is released. The spring brake chamber is divided into a pressurized chamber and a spring chamber (non-pressurized chamber). The spring brake actuator can be used as a parking brake or emergency brake in the event that the air pressure system fails. The spring brake actuator includes a compression spring placed in the spring chamber, which forces application of the brake when the air pressure is either released or lost.

In a conventional spring brake, one or more vent openings are provided in the side wall of the spring chamber so as to allow the interior of the spring chamber to remain at atmospheric pressure. These openings prevent the creation of a back pressure or vacuum in the spring chamber that could otherwise interfere with the proper operation of the spring brake. However, dirt, moisture and other unwanted material and contaminants such as salt from the outside environment may enter into the spring chamber through these openings, which may cause the corrosion of the compression spring and therefore reduce the lifetime of the spring brake. The foregoing drawback can be improved by using complex arrangements of valves and breather tubes to direct air flow between the spring chamber and other chambers in the brake actuator assembly. However, these arrangements require extra components and complex machining of the components. External filters placed over the vent openings and attached to the outside of the brake chambers may prevent contaminants from entering the brake chambers. However, the use of the external filters requires additional space, components, machining and assembly effort.

Therefore, a heretofore unaddressed need exists in the art to address the aforementioned deficiencies and inadequacies.

### SUMMARY OF THE INVENTION

In one aspect, the present invention relates to a spring brake chamber assembly. In one embodiment, the spring brake chamber assembly includes a first cup-shaped structure, a second cup-shaped structure and an adapter member connecting the first cup-shaped structure and the second cup-shaped structure to define a first housing between the first cup-shaped structure and the adapter member and a second housing between the second cup-shaped structure and the adapter member.

Furthermore, the spring brake chamber assembly includes a service brake diaphragm configured to be positioned in the second housing to divide the second housing into a ventilation chamber and a brake chamber, and reciprocally movable therein between a first position and a second position; a pressure plate configured to be positioned in a brake chamber and bearing against the service brake diaphragm; a compression spring configured to be positioned in the brake chamber, having a first end and a second end in contact with the pressure plate and the interior surface of the second cup-shaped structure, respectively; and a brake push rod1 extending from the pressure plate and passing through the compression spring and a central opening of the second cup-shaped structure.

Moreover, the spring brake chamber assembly includes a piston assembly housed in the first housing. The piston assembly has a spring brake diaphragm configured to be position in the first housing to divide the first housing into a breathing chamber and a pressurized chamber, and reciprocally movable therein between a first position and a second position; a pressure plate located in the breathing chamber and bearing against the spring brake diaphragm; and a piston rod having a first end portion passing through the spring brake diaphragm and terminating at the pressure plate, an opposite, second end portion passing through a central opening of the adapter member and terminated in the ventilation chamber, and a body portion defined therebetween, wherein the body portion defines an air passageway therein.

Additionally, the spring brake chamber assembly includes a power spring configured to be positioned in the breathing chamber, having a first end and a second end in contact with the interior surface of the first cup-shaped structure and the pressure plate, respectively; and a piston shaft passing through the power spring and having a first end portion mounted onto the first cup-shaped structure and an opposite, second end portion received in the air passageway of the piston rod. In one embodiment, the power spring is capable of moving reciprocally between a retracted position and an extended position. When the power spring moves from the retracted position toward the extended position, it causes the spring brake diaphragm to move from the first position toward the second position, thereby expanding the volume of the breathing chamber. When the power spring moves from the extended position toward the retracted position, it causes the spring brake diaphragm to move from the second position toward the first position, thereby retracting the volume of the breathing chamber.

The second cup-shaped structure is configured to allow no air directly flows between the breathing chamber and the atmosphere. The breathing chamber is in fluid communication with the ventilation chamber through the air passageway. In one embodiment, the spring brake chamber assembly has a vent port and a breathing port in fluid communication with the ventilation chamber and pressurized chamber, respectively.

The spring brake chamber assembly also includes a sealing member positioned in the central opening of the adapter member through which the second end portion of the piston rod passes and adapted for preventing air from flowing through between the pressurized chamber and the ventilation chamber, where the sealing member comprises one or more O-ring seals.

The spring brake chamber assembly may further include a valve mounted onto the second end portion of the piston rod for operably controlling the flow of air through the air passageway between the breathing chamber and the ventilation chamber. The valve is configured such that as the power spring moves from the retracted toward the extended position, compressed air is introduced to the breathing chamber from the ventilation chamber through the air passageway; as the power spring moves from the extended position toward the retracted position, compressed air is introduced from the breathing chamber to the ventilation chamber through the air passageway; and when the power spring is in the retracted position, compressed air is prevented from flowing from the ventilation chamber to the breathing chamber through the air passageway.

In one embodiment, the spring brake chamber assembly further includes a brake push rod guide 2 configured to be positioned in the central opening of the second cup-shaped structure for guiding reciprocal movement of the brake push rod 1 within the central opening of the second cup-shaped structure. As assembled, the piston shaft, the piston rod and the brake push rod 1 are coaxially aligned.

In another aspect, the present invention relates to a spring brake chamber assembly for actuating and releasing a brake in response to the introduction and/or exhaustion of compressed air. In one embodiment, the spring brake chamber assembly has a housing having a first housing and a second housing separated by a divider wall 1, each of the first housing and the second housing having a wall. The spring brake chamber assembly also has a first diaphragm configured to be positioned in the first housing to divide the first housing into a breathing chamber and a pressurized chamber, and reciprocally movable therein between a first position and a second position in response to the introduction and/or exhaustion of compressed air to the pressurized chamber, where the pressurized chamber has a breathing port for the introduction and/or exhaustion of compressed air. The spring brake chamber assembly further has a second diaphragm configured to be positioned in the second housing to divide the second housing into a ventilation chamber and a brake chamber, and reciprocally movable therein between a first position and a second position in response to the introduction and/or exhaustion of compressed air to the ventilation chamber. The ventilation chamber has a ventilation port for the introduction and/or exhaustion of compressed air. The breathing chamber and the pressurized chamber, the ventilation chamber and the brake chamber are connected in tandem. Furthermore, the spring brake chamber assembly has a flow control member passing through the pressurized chamber and extending between the breathing chamber and the ventilation chamber for selectively controlling the flow of air between the breathing chamber and the ventilation chamber. In one embodiment the flow control member comprises an air passageway.

In one embodiment, the wall of the breathing chamber is sealed such that no air directly flows through between the breathing chamber and the atmosphere. The pressurized chamber and the ventilation chamber are formed such that no air flows through between the pressurized chamber and the ventilation chamber. The breathing chamber is in fluid communication with the ventilation chamber through the flow control member.

In one embodiment, the spring brake chamber assembly also has a power spring configured to be positioned in the breathing chamber and being capable of moving reciprocally between a retracted position and an extended position in response to the introduction and/or exhaustion of compressed air. As the power spring moves from the retracted position toward the extended position, it causes the first diaphragm to move from the first position toward the second position, thereby expanding the volume of the breathing chamber. As the power spring moves from the extended position toward the retracted position, it causes the first diaphragm to move from the second position toward the first position, thereby retracting the volume of the breathing chamber. When the first diaphragm is the first position, the pressurized chamber has a maximal volume, while the spring chamber has a minimal volume, and when the first diaphragm is the second position, the pressurized chamber has a minimal volume, while the spring chamber has a maximal volume.

In one embodiment, the flow control member is configured such that as the power spring moves from the retracted toward the extended position, compressed air is introduced to the breathing chamber from the ventilation chamber through the air passageway; as the power spring moves from the extended position toward the retracted position, compressed air is introduced from the breathing chamber to the ventilation chamber through the air passageway; and when the power spring is in the retracted position, compressed air is prevented from flowing from the ventilation chamber to the breathing chamber through the air passageway.

The spring brake chamber assembly further has a compression spring configured to be positioned in the brake chamber of the second housing for reciprocally moving the second diaphragm between the first position and the second position in response to the introduction and/or exhaustion of compressed air to the ventilation chamber. When the second diaphragm is the first position, the brake chamber has a maximal volume, while the ventilation chamber has a minimal volume, and when the second diaphragm is the second position, the brake chamber has a minimal volume, while the ventilation chamber has a maximal volume.

In yet another aspect, the present invention relates to an automobile using the spring brake chamber assembly disclosed above.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawing illustrates one embodiment of the invention and, together with the written description, serves to explain the principles of the invention.

FIG. 1 is a cross-sectional view of a brake actuator according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

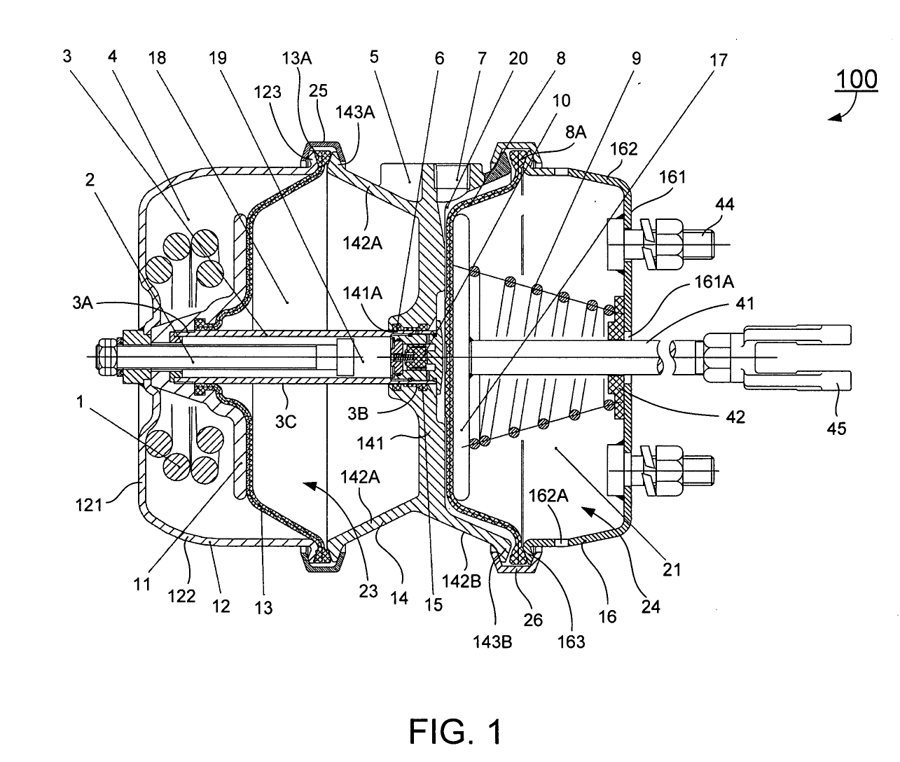

The description will be made as to the embodiment of the present invention in conjunction with the accompanying drawing of FIG. 1. In accordance with the purposes of this invention, as embodied and broadly described herein, this invention, in one aspect, relates to a spring brake chamber assembly having internally air-exchanged spring brake chambers usable for an automobile.

Referring to FIG. 1, a spring brake chamber assembly 100 is shown according to one embodiment of the present invention. The spring brake chamber assembly 100 includes a first cup-shaped structure 12 and a second cup-shaped structure 16. Each of the first and second cup-shaped structures 12 (16) has a base wall 121 (161) and a surrounding side wall 122 (162) extending from an edge of the base wall 121 (161), and a rim 123 (163) extending from an edge of the surrounding side wall 122 (162). The base wall 161 of the second cup-shaped structure 16 has an opening 161A formed in the center of the second cup-shaped structure 16. The spring brake chamber assembly 100 also includes an adapter member having a double cup-shaped structure 14 for connecting the first and second cup-shaped structures 12 and 16. The double cup-shaped structure 14 is also referred to as a flange case. As shown in FIG. 1, the double cup-shaped structure 14 has a divider wall 141, a first surrounding side wall 142A and a second surrounding side wall 142B extending oppositely from an edge of the divider wall 141. The double cup-shaped structure 14 also has a first rim 143A and a second rim 143B extending from edges of the first surrounding side wall 142A and the second surrounding side wall 142B, respectively. The divider wall 141 has an opening 141A formed in the center of the divider wall 141. As assembled, the rim 123 of the first cup-shaped structure 12 and the first rim 143A of the double cup-shaped structure 14 are mounted together by a first clamp 25, while the rim 163 of the second cup-shaped structure 16 and the second rim 143B of the double cup-shaped structure 14 are mounted together by a second clamp 26, thereby defining a first housing 23 between the first cup-shaped structure 12 and the double cup-shaped structure 14, and a second housing 24 between the second cup-shaped structure 16 and the double cup-shaped structure 14. The first housing 23 and the second housing 24 are also referred to as a spring brake chamber and a service brake chamber, respectively.

As shown in FIG. 1, the spring brake chamber assembly 100 includes a service brake diaphragm 8 having a peripheral rim 8A. The service brake diaphragm 8 is configured to be positioned in the second housing 24 and divides the second housing 24 into a ventilation chamber 20 and a brake chamber 21. In one embodiment, the peripheral rim 8A of the service brake diaphragm 8 is secured in an enclosure between the rim 163 of the second cup-shaped structure 16 and the second rim 143B of the double cup-shaped structure 14 by the second clamp 26. The service brake diaphragm 8 is made of an elastomeric material.

The service brake diaphragm 8 is reciprocally movable between a first position and a second position in the second housing 24. When the service brake diaphragm 8 is the first position, the brake chamber 21 has a maximal volume, while the ventilation chamber 20 has a minimal volume. However, when the service brake diaphragm 8 is the second position, the brake chamber 21 has a minimal volume, while the ventilation chamber 20 has a maximal volume. In FIG. 1, the service brake diaphragm 8 is in the first position. In operation, the ventilation chamber 20 is in fluid communication with a source of compressed air (or the atmosphere) through an air ventilation port 7 formed in the second surrounding side wall 142B of the double cup-shaped structure 14. The brake chamber 21 is vented to the atmosphere through one opening 162A formed in the surrounding side wall 162 of the second cup-shaped structure 16.

The spring brake chamber assembly 100 also includes a pressure plate 17 configured to be positioned in a brake chamber 21 and bearing against the service brake diaphragm 8. The spring brake chamber assembly 100 further has a compression spring 9 configured to be positioned in the brake chamber 21 of the second housing 24 such that its first end and its second end are in contact with the pressure plate 17 and a push rod guide 42 attached to the interior surface of the second cup-shaped structure 16, respectively. The compression spring 9 is adapted for reciprocally moving the second diaphragm 8 between the first position and the second position in response to the introduction and/or exhaustion of compressed air to the ventilation chamber 20. In FIG. 1, the ventilation chamber 20 is shown evacuated so that the service brake diaphragm 8 is forced against the adapter housing 20 because of the force from compression spring 9 in the brake chamber 21, and thus the service brake diaphragm 8 is in the first position.

As shown in FIG. 1, a brake push rod 41 extends from the pressure plate 17 and passing through the compression spring 9, the push rod guide 42, and the central opening 161A of the second cup-shaped structure 16, and has a clevis 45 adapted to connect to a brake shoe and drum (not shown) in a standard fashion. Reciprocating motion of the brake push rod 41 provides activating means for alternately applying and releasing the brake.

In operation, compressed air is introduced through the air ventilation port 7 into the ventilation chamber 20 to create a force against the second diaphragm 8 and the pressure plate 17 sufficient to overcome the force of the compression spring 9, thereby extending the brake push rod 41 toward the actuating position. The openings 162A permit rapid evacuation of air from the brake chamber 21 as the service brake is actuated. Mounting studs 44 are provided to mount the spring brake chamber assembly 100 onto a vehicle (not shown).

As shown in FIG. 1, the spring brake chamber assembly 100 also includes a piston assembly housed in the first housing 23. The piston assembly has a spring brake diaphragm 13, a pressure plate 11 located in the breathing chamber 4 and bearing against the spring brake diaphragm 13, and a piston rod 3. The spring brake diaphragm 13 is configured to be positioned in the first housing 23 and divides the first housing 23 into a breathing chamber 4 and a pressurized chamber 18. In one embodiment, the peripheral rim 13A of the spring brake diaphragm 13 is secured in an enclosure between the rim 123 of the first cup-shaped structure 12 and the first rim 143A of the double cup-shaped structure 14 by the first clamp 25. The first brake diaphragm 8 is made of an elastomeric material.

The spring brake diaphragm 13 is reciprocally movable between a first position and a second position in the first housing 23. When the spring brake diaphragm 13 is the first position, the pressurized chamber 18 has a maximal volume, while the breathing chamber 4 has a minimal volume. However, when the spring brake diaphragm 13 is the second position, the pressurized chamber 18 has a minimal volume, while the breathing chamber 4 has a maximal volume. In FIG. 1, the spring brake diaphragm 13 is in the first position.

The piston rod 3 has a first end portion 3A passing through the spring brake diaphragm 13 and terminating at the pressure plate 11, an opposite, second end portion 3B passing through a central opening 141 A of the double cup-shaped structure 14 and terminated in the ventilation chamber 20, and a body portion 3C defined therebetween. The body portion 3C defines an air passageway (a central bore) 19 therein. The piston rod 3 can also be formed in other forms such as a hollow tube.

A sealing member 10 is positioned in the central opening 141A of the divider wall 141 of the double cup-shaped structure 14 through which the second end portion 3B of the piston rod 3 passes. The sealing member 10 is adapted for preventing air from flowing through between the pressurized chamber 18 and the ventilation chamber 20. The sealing member 10 includes one or more O-ring seals.

Furthermore, the spring brake chamber assembly 100 includes a power spring 1 configured to be positioned in the breathing chamber 4 and extending between the interior surface of the base wall 121 of the first cup-shaped structure 12 and the pressure plate 11. The power spring 1 is capable of moving reciprocally between a retracted position and an extended position. When the power spring 1 moves from the retracted position toward the extended position, it causes the spring brake diaphragm 13 to move from the first position toward the second position, thereby expanding the volume of the breathing chamber 4. When the power spring 1 moves from the extended position toward the retracted position, it causes the spring brake diaphragm 13 to move from the second position toward the first position, thereby retracting the volume of the breathing chamber 4.

The spring brake chamber assembly 100 also includes a piston shaft 2 passing through the power spring 1 and having a first end portion 2A mounted onto the center of the base wall 121 of the first cup-shaped structure 12 and an opposite, second end portion 2B received in the air passageway 19 of the piston rod 3. As assembled, the piston shaft 2, the piston rod 3 and the brake push rod 41 are coaxially aligned.

Additionally, the spring brake chamber assembly 100 includes a valve 10 mounted onto the second end portion 3B of the piston rod 3 for operably controlling the flow of air through the air passageway 19 between the breathing chamber 4 and the ventilation chamber 20. The valve 10 is configured such that as the power spring 1 moves from the retracted toward the extended position, compressed air is introduced to the breathing chamber 4 from the ventilation chamber 20 through the air passageway 19; as the power spring 1 moves from the extended position toward the retracted position, compressed air is introduced from the breathing chamber 4 to the ventilation chamber 20 through the air passageway 19; and when the power spring 1 is in the retracted position, compressed air is prevented from flowing from the ventilation chamber 20 to the breathing chamber 4 through the air passageway 19.

During normal operation of the spring brake chamber assembly 100, the power spring 1 is in the retracted position, as shown in FIG. 1, by means of compressed air that is maintained in the pressurized chamber 18. When the compressed air is exhausted from the pressurized chamber 18, the power spring 1 forces the piston assembly that integrates the pressure plate 11, the spring brake diaphragm 13 and the piston push rod 3 to move in the direction towards the brake push rod 41. As a result, the spring brake diaphragm 13 moves from its first position toward its second position, and the piston rod 3 extends through the central opening 141A of the divider wall 141 of the double cup-shaped structure 14 into the ventilation chamber 20 of the second housing 24, thereby applying a force to the service brake diaphragm 8 and the pressure plate 17, which forces the service brake diaphragm 8 moves from its first position toward its second position. This action causes the brake push rod 41 to be extended toward the actuating position, thereby applying the brake (not shown). When the brake is released, compressed air is once again introduced into the pressurized chamber 18 to a pressure sufficient to overcome the force of the power spring 1. The force of the compressed air against the spring brake diaphragm 13 causes the pressure plate 11, the piston rod 3 and the power spring 1 to be returned to the position depicted in FIG. 1.

FIG. 1 shows a normal operating condition where the spring brake chamber assembly 100 is not actuated. In this condition, the pressurized chamber 18 is pressurized so that the spring brake diaphragm 13 and the pressure plate 11 keep the power spring 1 in the retracted position. Selective application of compressed air to the breathing chamber 4 causes the push rod 41 to apply the brakes (not shown) in the normal manner. In normal operating condition, the power spring 1 remains retracted and the spring brake diaphragm 13 is in its first (retracted) position, and the breathing chamber 4 is static and does not require an inflow of air through the control valve 10. Thus, the control valve 10 is in the closed position.

In the event of a loss of air pressure or intentional exhaustion of air from the pressurized chamber 18, the power spring 1 extends from its retracted position toward its extended position, thereby causing the spring bake diaphragm 13 to move from its first position toward its second position and the piston rod 3 to extend through the opening 141A of the divider wall 141 of the double cup-shaped structure 14 into the ventilation chamber 20 for applying the bake. Accordingly, the volume of the breathing chamber 4 is expanded. As the volume of the breathing chamber 4 increases, air must enter the expanded volume of the breathing chamber 4 to prevent a vacuum from forming in the breathing chamber 4. In this condition, the control valve 10 is open so as to allow air to flow from the air ventilation port 7 through the ventilation chamber 20 and the air passageway 19 into the expanding volume of the breathing chamber 4. The breathing chamber 4 is in an inhaling state in the case.

When the bake is released, compressed air is introduced into the pressurized chamber 18 through the breathing port 5, thereby causing the volume of the pressurized chamber 18 to expand. This action causes the spring brake diaphragm 11 to move from its second position toward its first position. Accordingly, the power spring 1 is retracted, the volume of the breathing chamber 4 contracts. Air the breathing chamber 4 must be evacuated out. In this condition, the control valve 10 is configured such that the air in the breathing chamber 4 flow though the air passageway 19, the ventilation chamber 20 and the air ventilation port 7 into the atmosphere. The breathing chamber 4 is in an exhaling (exhausting) state in the case.

According to the present invention, the wall of the breathing chamber 4 is sealed or solidly formed so that no air directly flows through between the breathing chamber 4 and the atmosphere. The breathing chamber 4 is in fluid communication with the ventilation chamber 20 through the air passageway 19, where in the ventilation chamber 20 is in fluid communication with the atmosphere through the ventilation port 7 formed in the second surrounding side wall 142B of the double cup-shaped structure 14. The pressurized chamber 18 is in fluid communication with a source of compressed air (or the atmosphere) through the breathing port 5 formed in the first surrounding side wall 142A of the double cup-shaped structure 14. Such an arrangement prevents dirt, moisture and other unwanted material and contaminants such as salt from entering the breathing chamber 4 from the outside environment.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A spring brake chamber assembly 100, comprising:
a. a first cup-shaped structure 12, a second cup-shaped structure 16 and an adapter member 14 configured to be positioned between the first cup-shaped structure 12 and the second cup-shaped structure 16 to define a first housing 23 between the first cup-shaped structure 14 and the adapter member 14 and a second housing 24 between the second cup-shaped structure 16 and the adapter member 14, respectively;
b. a service brake diaphragm 8 configured to be positioned in the second housing 24 to divide the second housing 24 into a ventilation chamber 20 and a brake chamber 21, and reciprocally movable therein between a first position and a second position;
c. a pressure plate 17 configured to be positioned in a brake chamber 21 and bearing against the service brake diaphragm 8;
d. a compression spring 9 configured to be positioned in the brake chamber 21, having a first end and a second end in contact with the pressure plate 17 and the interior surface of the second cup-shaped structure 16, respectively;
e. a brake push rod 41 extending from the pressure plate 17 and passing through the compression spring 9 and a central opening 161A of the second cup-shaped structure 16;
f. a piston assembly housed in the first housing 23, comprising:
(i) a spring brake diaphragm 13 configured to be positioned in the first housing 23 to divide the first housing 23 into a breathing chamber 4 and a pressurized chamber 18, and reciprocally movable therein between a first position and a second position;
(ii) a pressure plate 11 located in the breathing chamber 4 and bearing against the spring brake diaphragm 13; and
(iii) a piston rod 3 having a first end portion 3A passing through the spring brake diaphragm 13 and terminating at the pressure plate 11, an opposite, second end portion 3B passing through a central opening of the adapter member 14 and terminated in the ventilation chamber 20, and a body portion 3C defined therebetween, wherein the body portion 3C defines an air passageway 19 therein;
g. a power spring 1 configured to be positioned in the breathing chamber 4, having a first end and a second end in contact with the interior surface of the first cup-shaped structure 12 and the pressure plate 11, respectively; and
h. a piston shaft 2 passing through the power spring 1 and having a first end portion 2A mounted onto the first cup-shaped structure 12 and an opposite, second end portion 2B received in the air passageway 19 of the piston rod 3,
wherein the second cup-shaped structure 12 is configured to allow no air to directly flow between the breathing chamber 4 and the atmosphere, and wherein the breathing chamber 4 is in fluid communication with the ventilation chamber 20 through the air passageway 19.

2. The spring brake chamber assembly of claim 1, further comprising a brake push rod guide 42 configured to be positioned in the central opening 161 A of the second cup-shaped structure 16 for guiding reciprocal movement of the brake push rod 41 within the central opening 161A of the second cup-shaped structure 16.

3. The spring brake chamber assembly of claim 2, wherein as assembled, the piston shaft 2, the piston rod 3 and the brake push rod 41 are coaxially aligned.

4. The spring brake chamber assembly of claim 1, further comprising a vent port 5 and a breathing port 7 in fluid communication with the ventilation chamber 20 and pressurized chamber 18, respectively.

5. The spring brake chamber assembly of claim 1, further comprising a sealing member positioned in the central opening 141A of the adapter member 14 through which the second end portion 3B of the piston rod 3 passes and adapted for preventing air from flowing through between the pressurized chamber 18 and the ventilation chamber 20.

6. The spring brake chamber assembly of claim 5, wherein the sealing member comprises one or more O-ring seals.

7. The spring brake chamber assembly of claim 1, wherein the power spring 1 is capable of moving reciprocally between a retracted position and an extended position.

8. The spring brake chamber assembly of claim 7, wherein when the power spring 1 moves from the retracted position toward the extended position, it causes the spring brake diaphragm 13 to move from the first position toward the second position, thereby expanding the volume of the breathing chamber 4, and wherein when the power spring 1 moves from the extended position toward the retracted position, it causes the spring brake diaphragm 13 to move from the second position toward the first position, thereby retracting the volume of the breathing chamber 4.

9. The spring brake chamber assembly of claim 8, further comprising a valve 10 mounted onto the second end portion 3B of the piston rod 3 for operably controlling the flow of air through the air passageway 19 between the breathing chamber 4 and the ventilation chamber 20.

10. The spring brake chamber assembly of claim 9, wherein the valve 10 is configured such that
a. as the power spring 1 moves from the retracted toward the extended position, compressed air is introduced to the breathing chamber 4 from the ventilation chamber 20 through the air passageway 19;
b. as the power spring 1 moves from the extended position toward the retracted position, compressed air is introduced from the breathing chamber 4 to the ventilation chamber 20 through the air passageway 19; and
c. when the power spring 1 is in the retracted position, compressed air is prevented from flowing from the ventilation chamber 20 to the breathing chamber 4 through the air passageway 19.

11. A spring brake chamber assembly 100, comprising:
a. a first housing 23 and a second housing 24 separated by a divider wall 141, each of the first housing 23 and the second housing 24 having a wall;
b. a first diaphragm 13 configured to be positioned in the first housing 23 to divide the first housing 23into a breathing chamber 4 and a pressurized chamber 18, and reciprocally movable therein between a first position and a second position in response to the introduction and/or exhaustion of compressed air to the pressurized chamber 18, wherein the pressurized chamber 18 has a breathing port 5 for the introduction and/or exhaustion of compressed air;
c. a second diaphragm 8 configured to be positioned in the second housing 24 to divide the second housing 24 into a ventilation chamber 20 and a brake chamber 21, and reciprocally movable therein between a first position and a second position in response to the introduction and/or exhaustion of compressed air to the ventilation chamber 20, wherein the ventilation chamber 20 has a ventilation port 7 for the introduction and/or exhaustion of compressed air, and wherein the breathing chamber 4 and the pressurized chamber 18, the ventilation chamber 20 and the brake chamber 21 are connected in tandem; and
d. a flow control member passing through the pressurized chamber 18 and extending between the breathing chamber 4 and the ventilation chamber 20 for selectively controlling the flow of air between the breathing chamber 4 and the ventilation chamber 20,
wherein the wall of the breathing chamber 4 is sealed such that no air is allowed to directly flow through between the breathing chamber 4 and the atmosphere, and wherein the breathing chamber 4 is in fluid communication with the ventilation chamber 20 through the flow control member.

12. The spring brake chamber assembly of claim 11, wherein the pressurized chamber 18 and the ventilation chamber 20 are formed such that no air flows through between the pressurized chamber 18 and the ventilation chamber 20.

13. The spring brake chamber assembly of claim 11, further comprising a power spring 4 configured to be positioned in the breathing chamber 4 and being capable of moving reciprocally between a retracted position and an extended position in response to the introduction and/or exhaustion of compressed air.

14. The spring brake chamber assembly of claim 13, wherein as the power spring 1 moves from the retracted position toward the extended position, it causes the first diaphragm 13 to move from the first position toward the second position, thereby expanding the volume of the breathing chamber 4, and wherein as the power spring 1 moves from the extended position toward the retracted position, it causes the first diaphragm 13 to move from the second position toward the first position, thereby retracting the volume of the breathing chamber 4.

15. The spring brake chamber assembly of claim 14, wherein the flow control member comprises an air passageway 19.

16. The spring brake chamber assembly of claim 15, wherein the flow control member is configured such that
a. as the power spring 1 moves from the retracted toward the extended position, compressed air is introduced to the breathing chamber 4 from the ventilation chamber 20 through the air passageway 19;
b. as the power spring 1 moves from the extended position toward the retracted position, compressed air is introduced from the breathing chamber 4 to the ventilation chamber 20 through the air passageway 19; and
c. when the power spring 1 is in the retracted position, compressed air is prevented from flowing from the ventilation chamber 20 to the breathing chamber 4 through the air passageway 19.

17. The spring brake chamber assembly of claim 14, wherein when the first diaphragm 13 is the first position, the pressurized chamber 18 has a maximal volume, while the spring chamber 4 has a minimal volume, and wherein when the first diaphragm 13 is the second position, the pressurized chamber 18 has a minimal volume, while the spring chamber 4 has a maximal volume.

18. The spring brake chamber assembly of claim 11, further comprising a compression spring 9 configured to be positioned in the brake chamber of the second housing for reciprocally moving the second diaphragm 8 between the first position and the second position in response to the introduction and/or exhaustion of compressed air to the ventilation chamber 20.

19. The spring brake chamber assembly of claim 18, wherein when the second diaphragm 8 is the first position, the brake chamber 21 has a maximal volume, while the ventilation chamber 20 has a minimal volume, and wherein when the second diaphragm 8 is the second position, the brake chamber 21 has a minimal volume, while the ventilation chamber 20 has a maximal volume.

20. An automobile using the spring brake chamber assembly of claim 11.
